(19) United States
(12) Patent Application Publication
(10) Pub. No.: US 2005/0013103 A1
(43) Pub. Date: Jan. 20, 2005

(54) Multipurpose docking apparatus for a mobile computer

(76) Inventor: Adrian Chandley, Sammamish, WA (US)

Correspondence Address: WOODCOCK WASHBURN LLP, ONE LIBERTY PLACE - 46TH FLOOR, PHILADELPHIA, PA, 19103, US

(21) Appl. No.: 10/621,286

(22) Filed: Jul. 17, 2003

(51) Int. Cl. G06F 1/16

(52) U.S. Cl. 361/683

(57) ABSTRACT

An multipurpose docking apparatus for mobile or other computers for operation both with and without an installable mobile computer is presented. The multipurpose docking station includes a port for insertion of a handheld or other mobile computer or computer code. Without the mobile computer installed, the multipurpose docking apparatus is functional as a remote display or terminal for a personal computer. When the mobile computer is installed into the installation port, the combination is functional as a fully accessible computing system with the ability to communicate with other computers, peripherals and network interfaces.

### FIELD OF THE INVENTION

The invention relates generally to computer hardware, and more particularly to a configuration of docking stations accommodating mobile computers or mobile computer cores.

### BACKGROUND OF THE INVENTION

A recent evolution of the computer monitor or the display of a personal computer is the concept of the smart display. Initially developed by Microsoft®, a smart display is a wireless, touch screen monitor that lets you access and use a personal computer, such as a home computer, in a wireless local area network fashion. Such display devices allow remote access to a personal or business computer to allow the full use of the computer while away from the personal computer's fixed location. Users may perform such functions as connecting to the Internet, checking e-mail messages, downloading files and using other applications such as photo editing, money management, and CD ROM burning programs. A smart display may extend the power of the Windows XP Professional™ operating system and allow the user the mobility to travel anywhere within the wireless range of the smart display and still utilize the personal computer that has a fixed location.

Another recent evolution is that of full functionality handheld computers. These computers may be ultra compact computer cores also known as mobile computer cores centered around a processor, an internal battery, data storage, an optional display, and selected computer software applications. An example of such a handheld computer is the MetaPad™ developed by IBM® in the Yorktown Heights, New York facility. Such handheld computers are small and lightweight and possess computing resources equaling gigabit processors with multiple gigabit hard drives, and have ample dynamic random access memory, graphics drivers and multiple input/output ports.

The advantage of smart display types of technology is the mobility of full range display and access to all the resources of the remote host computer. A limitation to the smart display type is in its inability to act as an interconnected mobile processor in a peer accessible network. An advantage of a handheld computer is the extremely convenient size of the computer core and the ability to have mobile computing power. A limitation of the handheld computer is the inability to incorporate standard and convenient human-compatible input/output interfaces with the small computer core size. An advantage of a laptop docking station is the ability to expand a laptop computer to incorporate the convenient human-compatible input/output interfaces while the laptop is in a stationary position in a docking station. A limitation of the docking station is that the station serves no function unless a laptop is plugged into it. Also, only one user may utilize a docking station at one time. Additionally, the convenient user interfaces are then as immobile as the docking station, which are usually connected to large monitors, keyboards and other peripherals.

Thus there is a need for a docking station which is useful without a computer being installed, and once installed, is capable of both convenient human-compatible interfaces and peer networking abilities. The present invention addresses the aforementioned needs and solves them with an architecture for a multipurpose docking station compatible with mobile computers, such as ultra compact computers, computer cores, handheld computers, laptop computers and other portable computers.

### SUMMARY OF THE INVENTION

A mobile docking apparatus for operation both with and without an installable or dockable mobile computer is presented. The mobile docking station features an installation port for insertion or connection of a mobile computer. Without the mobile computer installed, the docking apparatus is functional as a remote display for a personal computer. When the mobile computer is installed into the installation port, the combination is functional as a fully accessible computing system with the ability to communicate with other computers, peripherals and network interfaces.

A system for communicating between a mobile docking station for an installable computer and at least one an external device includes a mobile docking station and at least one external computer for communicating with the mobile docking station. The mobile docking station may communicate with an external computer before the mobile computer is installed. The external computer may be the mobile computer. The docking station may communicate with an external device after a mobile computer is installed. The external device may be a remote computer or a peripheral.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented.

FIG. 2 depicts a configuration diagram in which aspects of the invention may be implemented while in smart display mode; and

FIG. 3 depicts a configuration diagram in which aspects of the invention may be implemented while in the computer docked mode.

### DETAILED DESCRIPTION OF ILLUSTRATIVE EMBODIMENTS

Overview

The present invention addresses the limitations of having a docking station for a mobile computer that has no utility unless a handheld, laptop or other computer or computer core is installed. The invention allows a docking station that is without a computer core to act as a smart display or other terminal and communicate to a personal computer or server thereby allowing remote access to all of the remote computer's resources. The invention also enhances the function of a docking station by providing peer to peer, or other network style interfaces to other computers in a local wireless network or other network while the computer core is installed.

Typical Computing Device

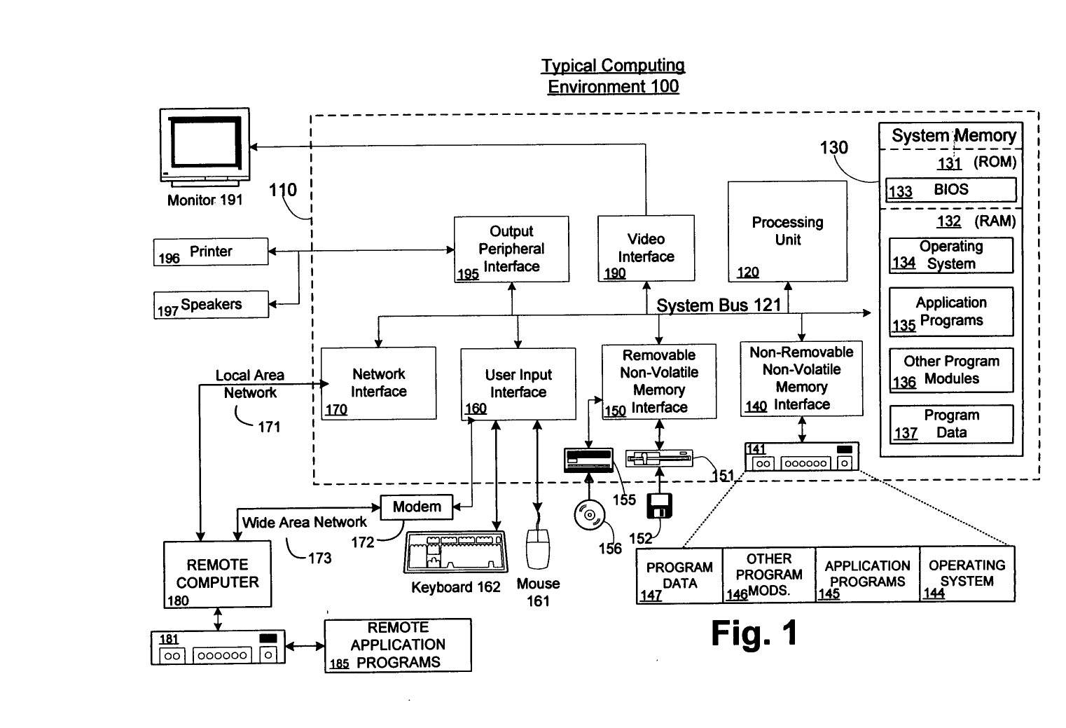

FIG. 1 and the following discussion are intended to provide a brief general description of a typical computing environment which form the point of reference for the invention. Other well known computing systems, environments, and/or configurations that may be suitable for use with the invention include, but are not limited to, personal computers (PCs), automated teller machines, server computers, hand-held or laptop devices, multiprocessor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 1 thus illustrates an example of a typical computing system environment 100 and is not intended to suggest any limitation as to the scope of use or functionality of the invention. Neither should the computing environment 100 be interpreted as having any dependency or requirement relating to any one or combination of components illustrated in the typical operating environment 100.

With reference to FIG. 1, a typical computing device may be in the form of a computer system 110. Components of computer system 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer system 110 typically includes a variety of computer readable media. Computer readable media can be any available media that can be accessed by computer system 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer system 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer system 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer system 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer system 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190, which may in turn communicate with video memory (not shown). In addition to monitor 191, computer systems may also include other peripheral output devices such as speakers 197 and printer 196, which may be connected through an output peripheral interface 195.

The computer system 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer system 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer system 110 is connected to the LAN 171 through a network interface or adapter 170. When used in a WAN networking environment, the computer system 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer system 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, One Microsoft Way, Redmond, Wash. 98052, includes servers, building-block services, such as Web-based data storage, and downloadable device software.

Exemplary Embodiments

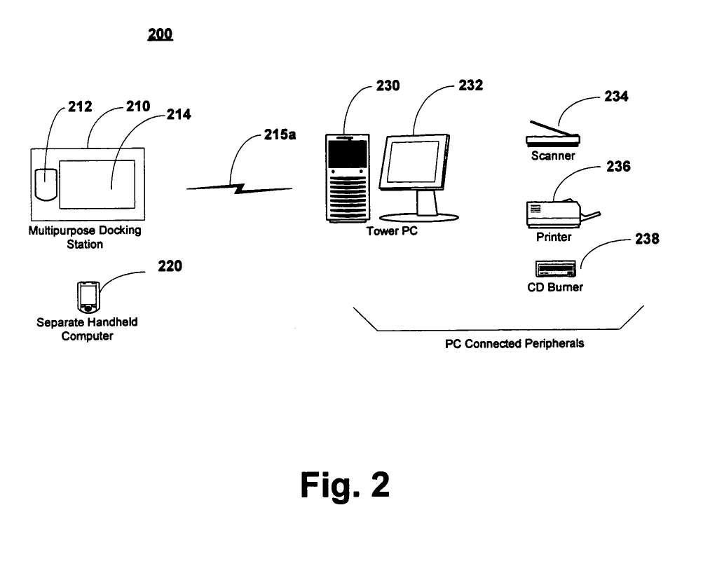

FIG. 2 depicts a configuration 200 of an exemplary system architecture embodying aspects of the current invention. A multipurpose docking station 210 is shown with exemplary interfaces when the docking station 210 does not have a handheld or other computer 220 inserted into the docking station bay 212. In this configuration, the handheld computer 220 is separate from the docking station 210 and therefore no hard-line communication exists between the docking station and the handheld computer 220. Although it may be possible to insert a wireless or a wire link between the handheld computer 220 and the docking station 210, such a configuration is not considered necessary in the FIG. 2 embodiment. The separate handheld computer 220 is only shown for reference in FIG. 2. The handheld computer 220 could also be any mobile computer, such as handheld computers, laptop computers or other computer cores. The docking station 210 with no handheld or other computer installed has built-in communication and other functional capabilities that are superior to traditional docking stations.

Preferably, the docking station 210 includes a display 214 and a set of wireless electronics to allow the docking station to communicate 215a in a wireless manner to a personal computer 230. Although a tower model personal computer is shown in FIG. 2, any personal computer which includes a central processor and a wireless link 215a may be used. Since the docking station has no computer of its own because the computer bay 212 is empty, the docking station acts in a smart display mode or terminal. A smart display allows the use of wireless or other networking technology to provide access to the computer 230 in order to utilize its computing and interface resources. The resources of the computer 230 also include the operating system software. An exemplary operating system running in the home computer 230 is the Windows XP Professional available from Microsoft® of Redmond, Wash. An alternate embodiment would include a docking station that had a wired connection to an external personal computer.

The wireless connection 215a between the docking station 210 and the personal computer 230 may be established by an IEEE 802.11b standard wireless adapter that lets the docking station 210 access the computer 230. The adapter, not shown in FIG. 2, may be built into the docking station 210. A typical maximum distance for the wireless interface may be in the range of 100 feet for the IEEE 802.11b standard. Typical interface technologies for implementation of a wireless link are radio frequency links, microwave links, infrared links and acoustical links.

In the configuration of FIG. 2, the docking station becomes a portable or fixed monitor for the computer 230 depending on user desires. The interface to the display 214 of the docking station 210 may be either or both of a stylus and a touch-sensitive screen, for example. A complete and/or customizable on-screen keyboard may be implemented as well as a writing pad with handwriting or stroke recognition. Support for a wireless mouse or a lightpen may also be provided. Other interface options on the docking station may include universal serial bus interfaces or other interfaces for a separate hardware mouse, keyboard or lightpen if so desired. Any other type of human interface, such as those that are specially implemented for the handicapped, may be accommodated as well as audio, tactile and vibration transducer interfaces.

The personal computer 230 may be configured as any typical stand-alone personal computer or network server connected to by one or more intelligent docking station or regular clients. For example, the configuration may include a set of peripherals such as a display 232, a scanner 234, a printer 236, and a CD ROM burner 238. It shall be understood that any resources, such as software and hardware resources, available to the personal computer 230 may be made available to the docking station 210 by virtue of the wireless interface 215a of the smart display mode of operation shown in FIG. 2. It should also be recognized that the docking station 210 can communicate with and utilize the resources of personal computer 230 even if personal computer or server 230 is without user input or output devices. For example, docking station 210 with bay 212 empty may be used as the sole but mobile display for the personal computer 230 if peripheral display 232 is not present. An application of this utility is the situation where a user leaves his mobile or laptop computer at home but wants to work in his office. With the current invention, the docking station 210 allows the user to utilize the resources of his office network including servers, printers, and scanners without the use of the mobile or laptop computer being present in the docking station.

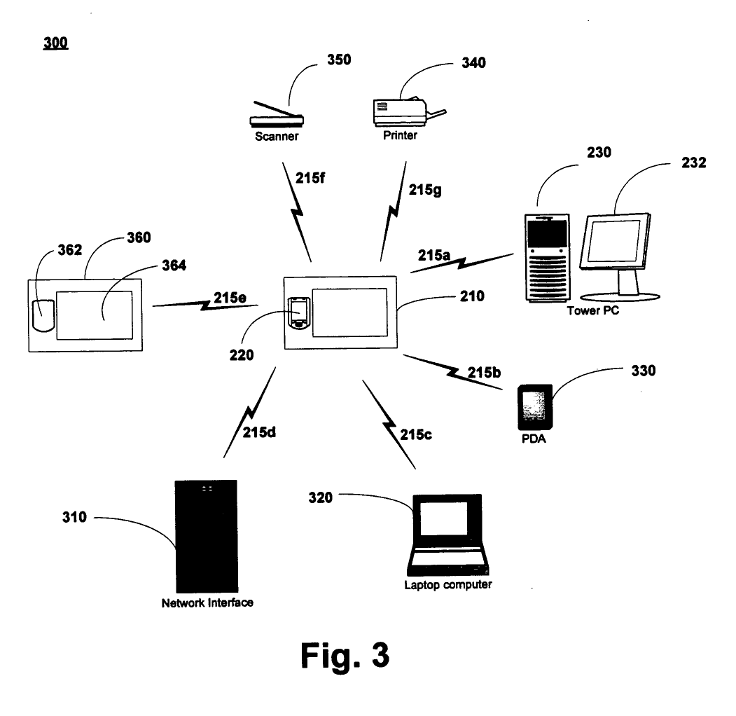

Not shown on FIG. 2 are the power supply options available to docking station 210. To allow complete and unfettered mobility, the docking station 210 may be fitted with internal batteries or fuel cells. If such batteries are rechargeable, then an interface for recharging and/or external power may be accommodated. This accommodation may also include an internal converter which may include an AC to DC power converter. Power supply options for the insertion bay 212 include charging the handheld or other mobile computer when installed (See FIG. 3, for example) and utilizing the internal power source conversion of the docking station for handheld or mobile computer purposes.

FIG. 3 depicts a configuration 300 of an exemplary system architecture embodying aspects of the current invention. The multipurpose docking station 210 of the current invention is shown with exemplary interfaces when the docking station 210 contains a mobile or other computer 220 inserted into the docking station bay or port (Refer to FIG. 2 to view the empty bay 212.) The docking station bay or port (212 of FIG. 2) may include electrical, mechanical, and thermal interfaces for the mobile computer 220. Electrical interfaces may include power control signal and data interfaces. These interfaces may be either as a result of mechanical insertion or optionally, via a cable or wireless interface (not shown in figure). The Mechanical interfaces include easy insertion, retention and ejection mechanisms or optionally, cable or wireless mechanical accommodations (not shown in figure). Thermal interfaces may include heat sinking or heat spreading interfaces as well as those of air circulation for the installed mobile or other computer 230.

In this configuration, the now-augmented docking station 210, now in computer docked mode, is fully supported by the computing resources of the handheld or other mobile computer 220. With the insertion of the handheld or other computer 220 into the docking station 210, the wireless communication interfaces 215a-g enable the handheld computer 220 to communicate through the docking station 210 to various peripherals, computers, and network interfaces. It shall be noted that although an IEEE 802.11b wireless interface standard may be used, other wireless interfaces for the various wireless links 215a-g may be utilized to complete the wireless connectivity of the invention. In addition to wireless, wire based networking is also available as a connectivity option.

When the handheld or other mobile computer 220 is installed, the combination now becomes equivalent to full a laptop or tablet computer. If the multipurpose docking station is in the style of a traditional fixed docking station, where the laptop sits atop of the multipurpose docking station, then the handheld or other mobile computer will have access to all the local docking resources and functions. In addition, with the FIG. 3 handheld or other mobile computer installed, the docking station 210 may still retain the ability to communicate with the personal computer 230 as in the FIG. 2 uninstalled configuration. It shall also be noted that installation of the handheld or other mobile computer into the multipurpose docking station may be made via cable or other form of electromechanical connection. A physical installation of a handheld or other mobile computer into or onto the multipurpose docking station, as shown in FIG. 3, is not strictly required by the invention. Any suitable means, known to those of skill in the art, may be utilized without escaping the spirit of the invention.

Other embodiments of the invention may include a wireless communication link to peer equipment. For example, wireless connection 215c to a laptop computer 320 essentially serves to emulate a wireless local area network. With the handheld computer 220 installed into the docking station 210, the connection 215a to the personal computer may essentially become a peer to peer connection. Such peer to peer connections allow the utility of a variety of peer-to peer transactions as may occur in network such as file sharing and joint program sharing as may be needed in, for example, peer to peer gaming or in an office setting. This capability also allows a guest user, having a laptop 320 or other mobile computer, to connect to a docking station 210 of another and share computer resources. Another embodiment may include a wireless communications interface 215d to a network interface device 310 which allows access to a local or wide area network or the Internet where peer to peer interfaces are commonly made along with stand-alone computing applications.

Another embodiment may include a wireless communications interface 215e to a second docking station 360. Here, a first, multipurpose docking station 210 may be used as the computing resource for a docking station of this invention operating in smart display mode. It is easy to envision a plurality of smart display mode docking stations or simply smart displays configured utilize the computing resources of one or more multipurpose docking stations where a mobile computer 230 is now installed. Such multiple docking station 360 devices may be connected 215e to at least one fully configured, multipurpose docking stations 210 forming a local area network. Once again, the geographic size of the local network may be determined by the capability of the wireless standard used, such as for example IEEE 802.

The system permutations of the invention may be applied to a variety of applications and devices. While exemplary programming languages, names and examples are chosen herein as representative of various choices, these languages, names and examples are not intended to be limiting.

The apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including mobile device operating systems and other application specific operating systems are contemplated, especially as the number of wireless networked devices continues to proliferate. Therefore, the present invention should not be limited to any single embodiment, but rather should be construed in breadth and scope in accordance with the appended claims.

1. A docking station for a computer comprising:
a port for receiving a mobile computer;
a communication interface for communicating with at least one external computer; and
a data transfer interface communicatively connected to a display for rendering information to the display;
wherein the docking station is itself mobile and enables the communication interface to acquire external computer information and enables the data transfer interface to display the external computer information when the mobile computer is not installed into the port; and wherein the docking station enables communications with the mobile computer when the mobile computer is installed into the port.

2. The docking station of claim 1, wherein the display is a display integrated with the docking station.

3. The docking station of claim 1, wherein the port for receiving the mobile computer comprises a connector.

4. The docking station of claim 3, wherein the port further receives a chassis for the mobile computer.

5. The docking station of claim 1, wherein the at least one external computer is the mobile computer.

6. The docking station of claim 1, further comprising a user interface comprising one or more of a keyboard, a mouse, a touchscreen, a lightpen, a stylus, audio interface, tactile transducer, vibration transducer and an external connector for an external input/output device permitting interaction with rendered information on the display.

7. The docking station of claim 1, further comprising a receptacle for receiving electrical power.

8. The docking station of claim 1, wherein the communication interface for communicating with at least one external computer is one or more of a wireless connection and a wired connection.

9. The docking station of claim 1, wherein the mobile computer is one of an ultra compact computer, a computer core, a handheld computer and a laptop computer.

10. A system supporting communications between a mobile docking station and at least one external computer comprising:
a mobile docking station comprising:
a port for receiving a mobile computer;
a communication interface for communicating with at least one external computer; and
a data transfer interface communicatively connected to a display for rendering information to the display;
at least one external computer for communicating with the mobile docking station;
wherein the mobile docking station enables the communications interface to support communication with the at least one external computer when the mobile computer is not installed; and wherein the mobile docking station supports communication with at least one external device when the mobile computer is installed.

11. The system of claim 10, wherein the display is a display integrated with the mobile docking station.

12. The system of claim 10, wherein the at least one external computer is the mobile computer.

13. The system of claim 10, further comprising a user interface comprising one or more of a keyboard, a mouse, a touchscreen, a lightpen, a stylus, audio interface, tactile transducer, vibration transducer and an external connector for an external input/output device permitting interaction with rendered information on the display.

14. The system of claim 10, wherein the communication interface for communicating with at least one external computer is one or more of a wireless connection and a wired connection.

15. The system of claim 14, wherein the wireless connection is one or more of a radio frequency connection, an infrared connection and an acoustic connection.

16. The system of claim 10, wherein the at least one external device is one or more of a remote computer and a peripheral device.

17. The system of claim 16, wherein the remote computer is one or more of a desktop computer and a laptop computer.

18. The system of claim 16, wherein the peripheral device is one or more of a peripheral device connected to a computer system and a standalone peripheral device.

19. The system of claim 10, wherein the at least one external device is one or more of a network interface, a personal digital assistant and one or more mobile docking stations.

20. The system of claim 10, wherein the mobile computer is one of an ultra compact computer, a computer core, a handheld computer and a laptop computer.
